(19) United States
(12) Patent Application Publication
(10) Pub. No.: US 2024/0406337 A1
(43) Pub. Date: Dec. 5, 2024

(54) INFORMATION PROCESSING APPARATUS, INFORMATION PROCESSING SYSTEM, METHOD FOR PROCESSING INFORMATION, AND RECORDING MEDIUM

(71) Applicants: Saki TAJIMA, Kanagawa (JP); Jun HITOSUGI, Tokyo (JP); Mizuho KIMURA, Kanagawa (JP); Masayuki TSUCHIYA, Tokyo (JP)

(72) Inventors: Saki TAJIMA, Kanagawa (JP); Jun HITOSUGI, Tokyo (JP); Mizuho KIMURA, Kanagawa (JP); Masayuki TSUCHIYA, Tokyo (JP)

(21) Appl. No.: 18/676,991

(22) Filed: May 29, 2024

(30) Foreign Application Priority Data
May 29, 2023 (JP) 2023-087702

(51) Int. Cl. H04N 1/60

(52) U.S. Cl. CPC H04N 1/6088; H04N 1/6097

(57) ABSTRACT

An information processing apparatus includes processing circuitry. The processing circuitry receives an input of environment information indicating an environment in which an image is observed and condition information indicating a condition for forming the image, and outputs setting information of an image forming apparatus that forms the image according to a combination of the environment information and the condition information.

### CROSS-REFERENCE TO RELATED APPLICATION

This patent application is based on and claims priority pursuant to 35 U.S.C. § 119(a) to Japanese Patent Application No. 2023-087702, filed on May 29, 2023, in the Japan Patent Office, the entire disclosure of which is hereby incorporated by reference herein.

### BACKGROUND

### Technical Field

The present disclosure relates to an information processing apparatus, an information processing system, a method for processing information, and a recording medium.

### Related Art

For example, in a concert venue, an event venue, an aquarium, a museum, an amusement facility, or the like, various effects are performed indoors and outdoors so that visitors can enjoy unusual experiences. For example, in a concert venue, there is a case where effects such as distributing a penlight or the like to visitors and allowing them to participate in light-up of the venue is performed. In such an effect, the visitors can feel a sense of unity of the entire venue by cooperating with the excitement of the venue.

Such an effect may include using various printed materials possessed by the visitors in the venue, such as entrance tickets carried by the visitors or leaflets, brochures, or posters distributed in the venue.

As an effect using various printed materials held by the visitors, for example, there is an example of using an invisible image (image which is hardly visible under visible light, but is visible under invisible light such as infrared light or ultraviolet light) printed on an entrance ticket in order to confirm authenticity of the entrance ticket of an amusement facility or the like. The invisible image in this case is a simple image that can be represented with a single color including, for example, numbers, characters, a quick-response (QR) code®, or a barcode. In this example, the staff of the amusement facility can confirm whether or not the entrance ticket is a counterfeit by irradiating the entrance ticket with the ultraviolet light emitted from the black light.

For example, an image forming apparatus can print an invisible image that can be visually recognized when an infrared camera is used but is difficult to visually recognize with naked eyes by using a toner containing an infrared absorbing material. Further, for example, a print control apparatus reduces a difference in color appearance due to a difference in light sources by performing color conversion with reference to a three-dimensional color conversion table in which measures for a plurality of light sources are taken.

### SUMMARY

According to an embodiment of the present disclosure, an information processing apparatus includes processing circuitry. The processing circuitry receives an input of environment information indicating an environment in which an image is observed and condition information indicating a condition for forming the image, and outputs setting information of an image forming apparatus that forms the image according to a combination of the environment information and the condition information.

According to another embodiment of the present disclosure, an information processing system includes a terminal device and an information processing apparatus to communicate with the terminal device via a network. The terminal device includes processing circuitry configured to transmit environment information indicating an environment in which an image is observed and condition information indicating a condition for forming the image to the information processing apparatus, and receive setting information of an image forming apparatus for forming the image from the information processing apparatus. The information processing apparatus includes processing circuitry configured to receive the environment information and the condition information from the terminal device, and transmit the setting information to the terminal device according to a combination of the environment information and the condition information.

According to still another embodiment of the present disclosure, a method for processing information causes a computer to execute receiving and outputting. The receiving receives an input of environment information indicating an environment in which an image is observed and condition information indicating a condition for forming the image. The outputting outputs setting information of an image forming apparatus that forms the image according to a combination of the environment information and the condition information.

According to still yet another embodiment of the present disclosure, a non-transitory recording medium stores a plurality of instructions which, when executed by one or more processors, causes the one or more processors to perform a method, includes receiving and outputting. The receiving receives an input of environment information indicating an environment in which an image is observed and condition information indicating a condition for forming the image. The outputting outputs setting information of an image forming apparatus that forms the image according to a combination of the environment information and the condition information.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a usage scene of a printed material according to an embodiment;

FIGS. 2A to 2F are diagrams illustrating examples of printed materials according to an embodiment;

FIG. 3 is a diagram illustrating an example of an effect using a printed material according to an embodiment;

FIG. 4 is a schematic diagram illustrating a relationship between companies according to an embodiment;

FIG. 5 is a schematic diagram illustrating an example of an overall configuration of a printing system according to an embodiment;

FIG. 6 is a schematic configuration diagram of a copier according to an embodiment;

FIGS. 7A and 7B are schematic diagrams illustrating an example of a state of a toner image and a toner layer formed by a copier according to an embodiment;

FIG. 8 is a block diagram illustrating a hardware configuration of a computer according to an embodiment;

FIG. 9 is a block diagram illustrating an example of a functional configuration of a printing system according to an embodiment;

FIG. 10 is a flowchart illustrating an example of a processing procedure of a printing method according to an embodiment;

FIG. 11 is a diagram illustrating an example of a request screen according to an embodiment;

FIG. 12 is a diagram illustrating an example of a wavelength conversion table according to an embodiment; and

FIG. 13 is a diagram illustrating an example of a setting information table according to an embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of the present disclosure are described in detail with reference to the drawings. In the drawings, components having the same functions are denoted by the same reference numerals, and redundant description is omitted.

Below, a description is given of an embodiment of the present disclosure.

An embodiment of the present disclosure is a printing system that manufactures printed materials used in various facilities or venues. In the present embodiment, an image forming apparatus having a function of forming an invisible image on an image forming medium is used. In addition, the printing system according to the present embodiment has a function of providing setting information of the image forming apparatus to the user so that an invisible image can be appropriately observed in an environment in which a printed material is used.

### Usage Scene of Invisible Image

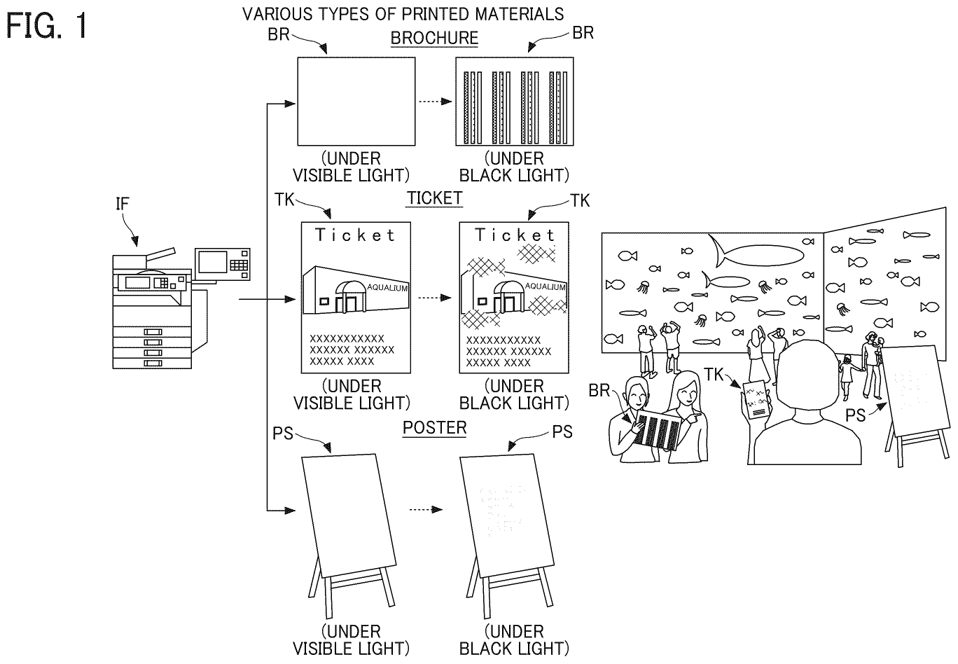

First, a usage scene of a printed material printed by the printing system according to the present embodiment is described. FIG. 1 is a diagram illustrating an example of a usage scene of a printed material according to the present embodiment;

The image forming apparatus IF of the printing system according to the present embodiment prints various printed materials including a brochure BR, a ticket TK, and a poster PS. Each of the brochure BR, the ticket TK, and the poster PS includes an invisible image, which is invisible or hardly visible under visible light (in a bright place) but visible under a black light (in a dark place). The brochure BR, the ticket TK, and the poster PS are used such that the invisible image printed on each of the brochure BR, the ticket TK, and the poster PS is visually recognized in a dark place (in the example illustrated in FIG. 1, in an exhibition room of an aquarium).

The image forming apparatus IF can express an arbitrary invisible color (a color that can be visible under invisible light but is hardly visible under visible light) by superimposing invisible green, invisible red, and invisible blue. The invisible green refers to a green color that can be visible under invisible light but is hardly visible under visible light. The invisible red refers to a red color that can be visible under invisible light but is hardly visible under visible light. The invisible blue refers to a blue color that can be visible under invisible light but is hardly visible under visible light.

Visible light is a form of electromagnetic radiation having a wavelength that is perceived as light by humans. Invisible light is a form of electromagnetic radiation having a wavelength other than a wavelength of visible light. In the present embodiment, invisible light is long-wavelength ultraviolet light emitted by, for example, a black light. In the present embodiment, the invisible color is transparent under light emitted from a fluorescent lamp or visible light such as sunlight, and becomes visible under invisible light such as ultraviolet light emitted from a black light.

Specifically, an invisible green image is formed with an invisible green toner. An invisible red image is formed with an invisible red toner. An invisible blue image is formed with an invisible blue toner. In the following description, the invisible green toner, the invisible red toner, and the invisible blue toner may be referred to as “G toner”, “R toner”, and “B toner”, respectively. An image of an invisible color other than the colors of the invisible green, the invisible red, and the invisible blue is formed with at least two of the invisible color toners (i.e., at least two of the G toner, the R toner, and the B toner) superimposed one atop another.

The invisible black, which is a black color visible under invisible light, is formed by adhering none of the G toner, the R toner, and the B toner. In addition, a special color image visible under visible light is formed by a special color toner (hereinafter, referred to as “S toner”.), and a black image visible under visible light is formed by a black toner (hereinafter, referred to as “K toner”).

In the present embodiment, a transparent toner (clear toner) and a transparent phosphor are combined to generate the invisible color toner. In other words, the invisible color toner is typically generated with the clear toner as a base. The transparent phosphor is, for example, a transparent fluorescent pigment or a transparent fluorescent dye. In the present embodiment, the invisible color toner is a pulverized toner having a fixing temperature higher than that of a polymerization toner. Alternatively, the invisible color toner may be a polymerization toner.

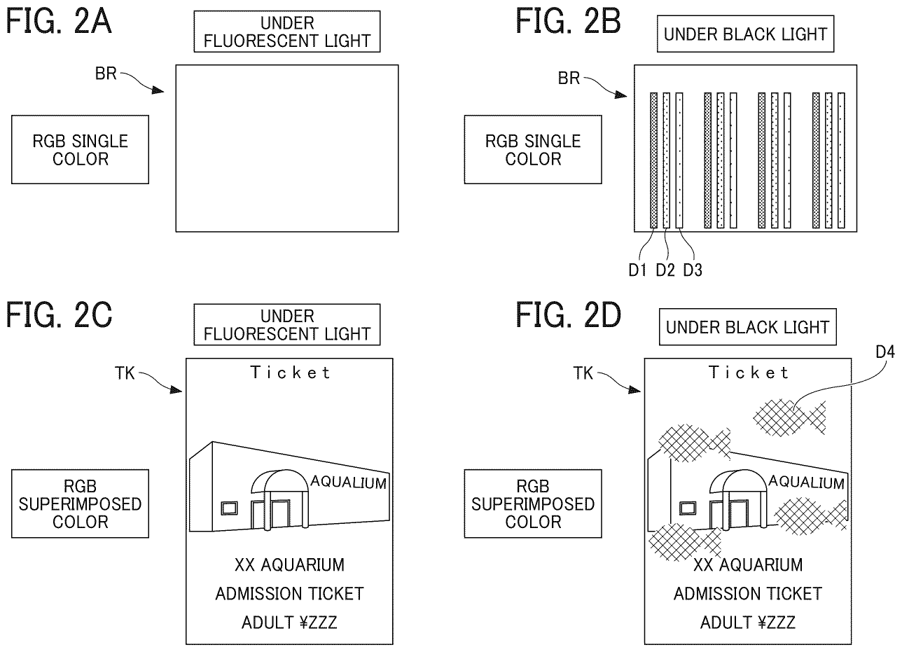

FIGS. 2A to 2F are diagrams illustrating examples of printed materials according to the present embodiment. FIGS. 2A and 2B are plan views of a brochure BR including, as a cover, paper pieces on which an invisible red monochrome image DI formed by R toner, an invisible green monochrome image D2 formed by G toner, and an invisible blue monochrome image D3 formed by B toner are printed not overlapping each other. FIG. 2A illustrates the state of brochure BR placed under fluorescent light (under visible light), and FIG. 2B illustrates the state of brochure BR placed under black light (under invisible light). In FIG. 2A, for the purpose of clarity, illustration of characters, patterns, and the like visible under visible light is omitted.

FIGS. 2C and 2D are plan views of a ticket TK that is a strip-shaped sheet on which a full-color image D4 of an invisible color formed by superimposing R toner, G toner, and B toner is printed. FIG. 2C illustrates a state of ticket TK placed under a fluorescent light (under visible light), and FIG. 2D illustrates a state of ticket TK placed under a black light (under invisible light).

FIGS. 2E and 2F are perspective views of a standing signboard (floor-standing poster) to which a poster PS, which is a large piece of paper on which characters D5 of an invisible color formed by superimposing R toner, G toner, and B toner are printed, is attached. FIG. 2E illustrates a state of a standing signboard (poster PS) placed under fluorescent light (under visible light), and FIG. 2F illustrates a state of a standing signboard (poster PS) placed under black light (under invisible light). In FIG. 2E, for the purpose of clarity, illustration of characters, patterns, and the like that can be visible under visible light is omitted.

As described above, the brochure BR, the ticket TK, and the poster PS, which are the printed materials in the present embodiment, can have an image (an image of an invisible color) that can be visually recognized under a black light but cannot be visually recognized under a fluorescent light. Therefore, an operator of a facility, a venue, or the like can realize various effects by using these printed materials.

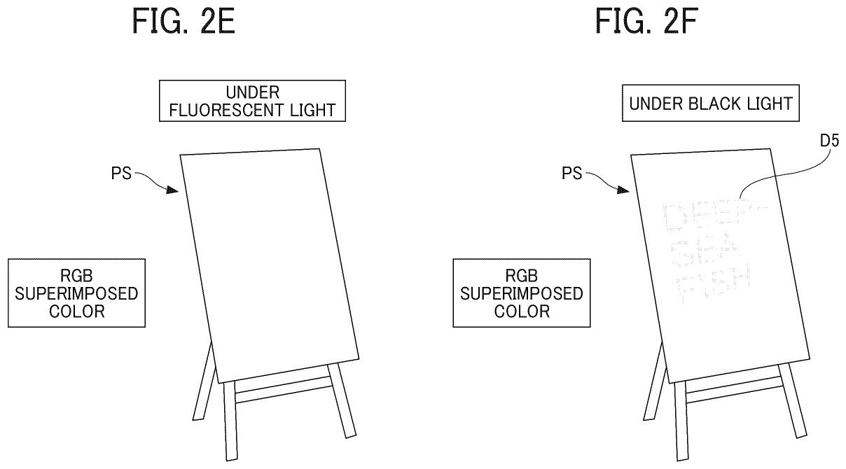

FIG. 3 is a diagram illustrating an example of an effect using a printed material in the present embodiment. The brochure BR, the ticket TK, and the poster PS illustrated in FIG. 3 are printed materials printed by the printing system according to the present embodiment. The brochure BR is a booklet for explaining the aquarium, the ticket TK is an entrance ticket for the aquarium, and the poster PS is a large piece of paper for explaining a living thing displayed in each display room of the aquarium.

On the brochure BR, the ticket TK, and the poster PS, an invisible color image is printed separately from a visible color image formed by a visible color toner such as the K toner. Note that an image of another invisible color such as a number, a character, a QR code®. or a bar code for confirming the authenticity of the ticket TK may be printed on the ticket TK.

Specifically, FIG. 3 illustrates an exhibition room of the aquarium. This exhibition room is an exhibition room of organisms (exhibits) such as corals, deep-sea fish, or jellyfish that fluoresce in response to a black light, and the entire exhibition room is irradiated by the black light so that the exhibit emits light (fluorescence) while being kept as dark as possible to express being in the sea. Since the black light does not cause things or living creatures that do not contain a fluorescent material such as a fluorescent agent to emit light, the black light does not brighten the surroundings unlike, for example, a fluorescent lamp. For this reason, the black light can respond to a demand for making only a specific object (for example, an exhibit and a reading object related to the exhibit) visible while making a space representing the inside of the sea, such as the exhibition room, as dark as possible.

When visitors enter the exhibition room, the invisible full-color image D4 appears in, for example, a portion where nothing appears to be drawn under visible light until the visitors enter the exhibition room, a portion where something appears to be drawn but it is difficult to clearly see what is drawn, or a portion where another visible color image is drawn, on each of the tickets TK held by the visitors to the aquarium. In the example illustrated, the invisible full-color image D4 includes an image of the same fish as the fish swimming in a water tank. This effect gives surprise to the visitors who have the tickets TK and brings about an effect that the visitors can share an extraordinary experience or that the sense of unity of the visitors can be enhanced through the common experience. The same applies to the effects produced with invisible images printed on the brochures BR held by the visitors to the aquarium.

When the poster PS that is attached to the standing signboard placed in the exhibition room is irradiated by the black light, the invisible characters D5 appear on the poster PS. In the example illustrated, the invisible characters D5 indicate “deep-sea fish” as a type of fish swimming in the aquarium. This effect brings about an effect that visitors can read the characters D5 in the dark exhibition room and obtain information on living creatures in the aquarium.

Such an effect can be produced in a place other than an aquarium, such as a concert hall, an event hall, a museum, or an amusement park, regardless of whether the place is indoors or outdoors, provided that a given light environment is attained.

An effect can be also produced with a printed material other than the printed materials held by the visitors to the place where the given light environment is attained, such as the distributed tickets TK or brochures BR, or the printed material placed in the place where the given light environment is attained, such as the poster PS stuck to a standing signboard. For example, an effect can be produced with a printed material such as a label that can be attached to a carrier bag or clothes.

### Relationship Between Companies

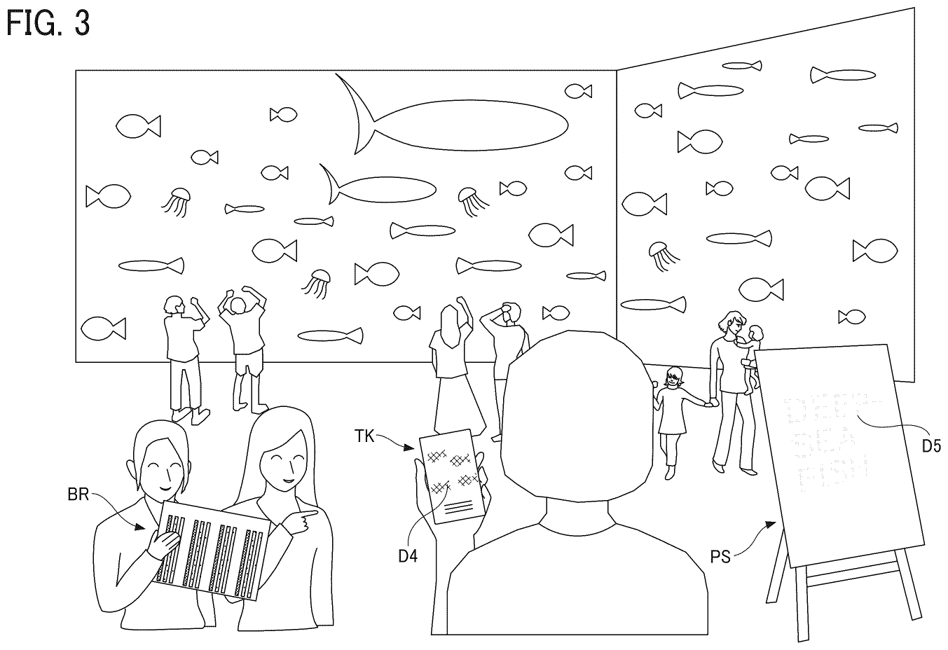

Next, a relationship between companies according to the present embodiment is described with reference to FIG. 4. FIG. 4 is a schematic diagram illustrating a relationship between companies according to the present embodiment.

As illustrated in FIG. 4, the facility operator A is a company that operates a facility that uses printed materials. The printer B is a company that manufactures printed materials in response to a request from the facility operator A. In the present embodiment, the printer B provides the facility operator A with a service of manufacturing a printed material on which an invisible image is formed using the image forming apparatus IF. The service provider C is a company that provides setting information of the image forming apparatus IF to the printer B. The service provider C may be, for example, a manufacturer or a seller of the image forming apparatus IF.

Here, an outline of processing in the present embodiment is described. In step S1, the facility operator A requests the printer B to manufacture the printed material. This request may not be made directly from the facility operator A to the printer B, and may be made using, for example, an intermediary service that mediates the print request via the Internet. In step S1, the information regarding the invisible image to be formed on the printed material, the environment in which an invisible image is observed, the conditions for forming the invisible image, and the like is provided from the facility operator A to the printer B.

In step S2, the printer B requests the service provider C for setting information of the image forming apparatus IF. In step S2, the information regarding the environment and conditions provided from the facility operator A to the printer B is provided to the service provider C. At this time, the printer B may add a condition related to printing and provide the condition to the service provider C.

In step S3, the service provider C generates setting information corresponding to the information regarding the environment and conditions provided from the printer B, and provides the setting information to the printer B. The service provider C generates the setting information such that the invisible image formed on the printed material can be appropriately observed under the environment and conditions provided by the printer B.

In step S4, the printer B operates the image forming apparatus IF using the setting information provided from the service provider C, and manufactures the printed material requested in step S1. In step S5, the printer B delivers the printed material manufactured in step S4 to the facility operator A. In step S6, the facility operator A realizes a desired effect in the facility using the printed material delivered from the printer B.

### Overall Configuration of Printing System

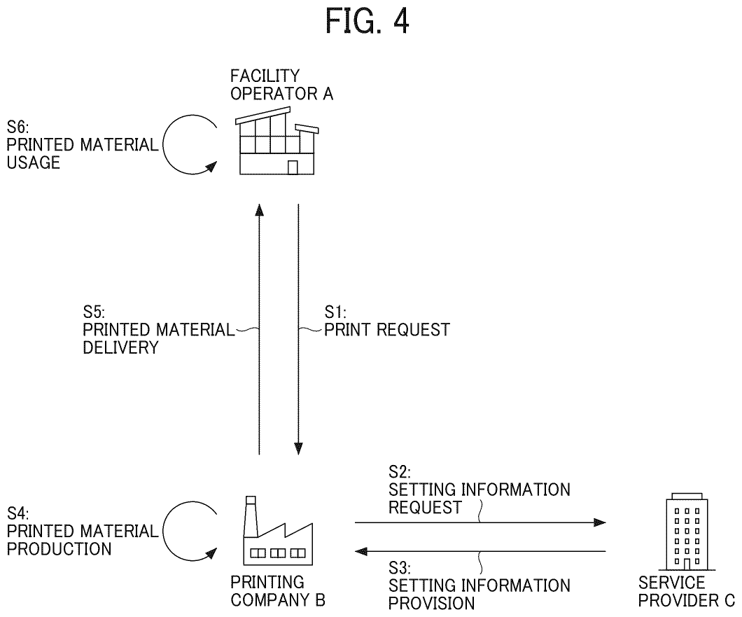

Referring to FIG. 5, a description is given below of the overall configuration of a printing system according to the present embodiment. FIG. 5 is a schematic diagram illustrating an example of an overall configuration of a printing system according to the present embodiment.

As illustrated in FIG. 5, the printing system 1000 according to the present embodiment includes a customer terminal 10, a user terminal 20, a provision server 30, and an image forming apparatus IF. Each of the customer terminal 10, the user terminal 20, and the provision server 30 is connected to a communication network N1. The user terminal 20 and the image forming apparatus IF are communicably connected to each other via a communication path N2. The communication network N1 allows the devices that are connected to the communication network N1 to communicate with each other.

The communication network N1 is constructed by a network by wired communication such as the Internet, a local area network (LAN), or a wide area network (WAN). The communication network N1 may include not only wired communication but also, for example, a network by wireless communication such as wireless LAN or near field communication, or mobile communication such as Worldwide Interoperability for Microwave Access (WiMAX), Long Term Evolution (LTE), or 5th Generation (5G).

In the present embodiment, the customer terminal 10 is installed in a facility or the like of the facility operator A. The user terminal 20 and the image forming apparatus IF are installed in a printing factory or the like of the printer B. The provision server 30 is installed in a facility or the like owned by the service provider C.

The customer terminal 10 is an information processing apparatus operated by a customer who requests manufacturing of a printed materials. An example of the customer terminal 10 is a computer such as a personal computer, a smartphone, or a tablet terminal. The customer who operates the customer terminal 10 is, for example, an employee of the facility operator A. The customer who operates the customer terminal 10 may be, for example, an employee of a business operator who is entrusted with the operation of the facility by the facility operator A. The customer terminal 10 can also be referred to as a facility operation terminal, a facility operation side terminal, or the like.

The user terminal 20 is an information processing apparatus operated by a user who uses the image forming apparatus IF. An example of the user terminal 20 is a computer such as a personal computer, a smartphone, or a tablet terminal. The user who operates the user terminal 20 is, for example, an employee of the printer B, a person who performs printing using the image forming apparatus IF, or the like. The user terminal 20 can also be referred to as a printer terminal, a printing terminal, or the like.

The user terminal 20 includes a digital front end (DFE; A software called Digital Front End) that may be installed. The digital front end is software that is connected to the image forming apparatus and transmits a print job to the image forming apparatus.

The provision server 30 is an information processing apparatus that provides a profile providing service. The profile providing service is an information communication service that provides an image forming profile of the image forming apparatus IF through a network such as the Internet. The provision server 30 receives an acquisition request for the image forming profile from the user terminal 20, and transmits the image forming profile corresponding to the acquisition request to the user terminal 20.

The image forming apparatus IF is an image forming apparatus that forms an image on an image forming medium. The image forming apparatus IF has a function of forming an invisible image on an image forming medium according to an image forming profile. The image forming profile is set in a print job input from the user terminal 20 to the image forming apparatus IF via the communication path N2. The image forming apparatus IF may perform an operation such as start, pause, resume, or end of the image forming process from an operation screen displayed on the operation panel.

The customer terminal 10 and the user terminal 20 are not limited to the information processing apparatus as long as they are devices having a communication function. The customer terminal 10 or the user terminal 20 may be, for example, an output device such as a projector (PJ), an Interactive White Board (IWB: a white board having an electronic blackboard function that allows mutual communication), and a digital signage, and a head up display (HUD) device, an industrial machine, an imaging device, a sound collecting device, a medical device, a network home appliance, an automobile (Connected Car), a notebook personal computer (PC), a mobile phone, a smartphone, a tablet terminal, a game machine, a personal digital assistant (PDA), a digital camera, a wearable PC, a desktop PC, or the like.

The overall configuration of the printing system 1000 illustrated in FIG. 5 is merely an example. Various system configurations may be employed depending on the use or purposes. For example, a plurality of customer terminals 10, user terminals 20, provision servers 30, or image forming apparatuses IF may be included in the printing system 1000. For example, the provision server 30 may be realized by a plurality of computers or may be realized as a cloud computing service. The device division such as the customer terminal 10, the user terminal 20, the provision server 30, or the image forming apparatus IF illustrated in FIG. 5 is an example.

### Image Forming Apparatus

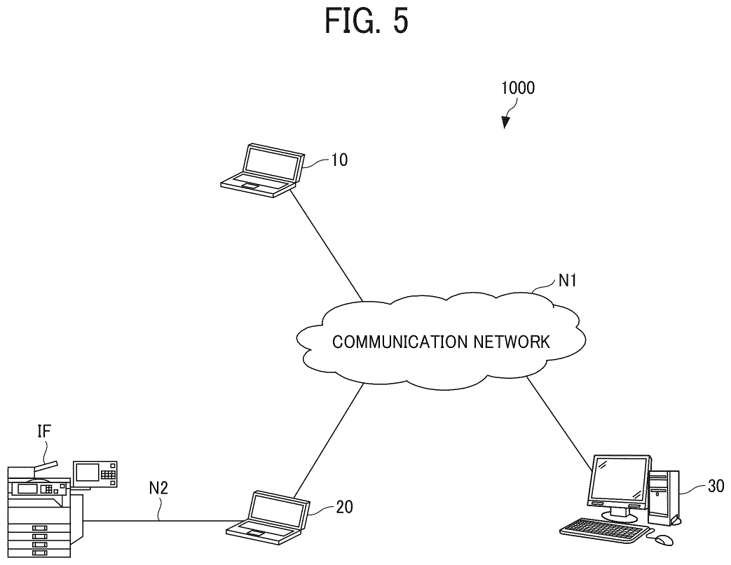

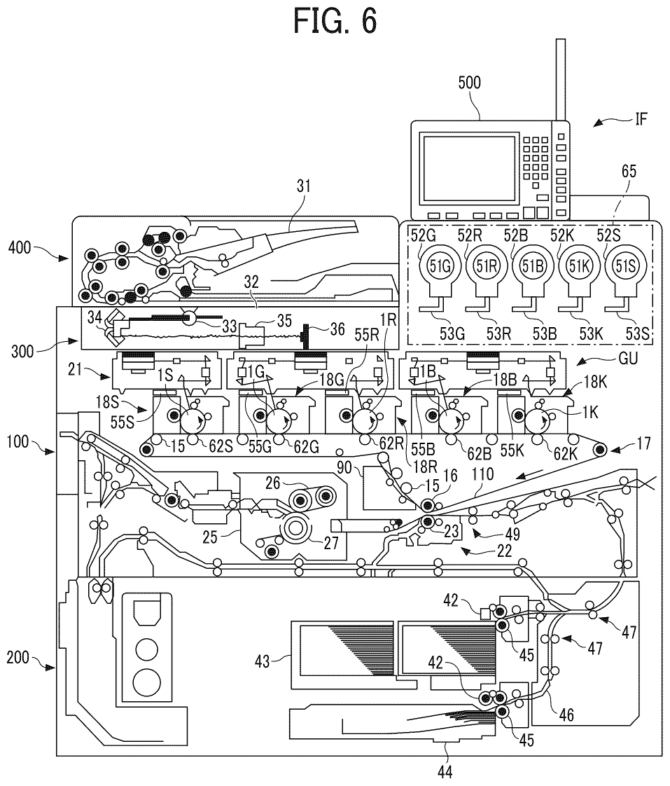

An image forming apparatus according to the present embodiment is described with reference to FIGS. 6 to 7B. An example of the image forming apparatus according to the present embodiment is a tandem color laser copying machine (hereinafter, simply referred to as a “copier”) in which a plurality of photoconductors is arranged in parallel.

Referring to FIG. 6, a description is given below of a basic configuration of the copier according to the present embodiment. FIG. 6 is a schematic configuration diagram of the copier according to the present embodiment. The copier is an electrophotographic image forming apparatus, and includes a printer 100, a feeding device 200, a scanner 300, an automatic document feeder 400, and the like. However, as long as the image forming apparatus IF according to the present embodiment is a printing apparatus having a printing function of printing and outputting a printed material, the image forming apparatus IF may include some of these, and is not limited by the designation.

The printer 100 includes an imaging unit GU having five developing stations 18S, 18G, 18R, 18B, and 18K for forming images of the respective colors, the special color (S: Special), the invisible green (G: Invisible Green), the invisible red (R: Invisible Red), the invisible blue (B: Invisible Blue), and the black (K: Key plate). Suffixes S, G, R, B, and K appended to the numeral “18” of reference numerals 18S, 18G, 18R, 18B, and 18K indicate that the developing stations 18S, 18G, 18R, 18B, and 18K are components for the colors of special color, invisible green, invisible red, invisible blue, and black, respectively. The same applies to other reference numerals used in the following description. In the following description, the suffixes S, G, R, B, and K denote the colors of special color, invisible green, invisible red, invisible blue, and black, respectively. To simplify the description, these suffixes are omitted unless necessary. The special color is a generic term for any color different from the colors of invisible green, invisible red, invisible blue, and black. The black refers to a black that is visible under visible light, and the special color refers to a special color that is visible under visible light.

In the housing of the printer 100, in addition to the developing stations 18S, 18G, 18R, 18B, and 18K, an optical writing device 21, an intermediate transfer device 17, a secondary transfer device 22, a registration roller pair 49, a belt fixing type fixing device 25, and the like are disposed.

The optical writing device 21 includes a light source, a polygon mirror, an f-θ lens, a reflection mirror, and the like, and irradiates the surfaces of the photoconductors 1S, 1G, 1R, 1B, and 1K with laser light based on image data.

The developing stations 18S, 18G, 18R, 18B, and 18K include a charging roller, a developing device, a drum cleaning device, a neutralization lamp, and the like in addition to the drum-shaped photoconductors 1S, 1G, 1R, 1B, and 1K.

The surface of the photoconductor 1S in the developing station 18S for S (special color) is uniformly charged by the charging roller serving as the charging means. The charged surface of the photoconductor 1S is irradiated with laser light modulated and deflected by the optical writing device 21. Then, the potential of the irradiated portion (exposed portion) of the surface of the photoconductor 1S is attenuated. Due to this attenuation, an electrostatic latent image for S is formed on the surface of the photoconductor 1S. The electrostatic latent image for S thus formed is developed by the developing device serving as the developing means to be an S toner image.

The S toner image formed on the photoconductor 1S for S is primarily transferred to an intermediate transfer belt 110. After the primary transfer, the residual toner is removed by the drum cleaning device from the surface of the photoconductor 1S.

In the developing station 18S for S, the photoconductor 1S removed by the drum cleaning device is neutralized by the neutralizer. Then, the photoconductor 1S is uniformly charged by the charger and returns to the initial state. The above-described series of processes is similarly performed in the developing stations 18G, 18R, 18B and 18K for the colors of G, R, B, and K.

The intermediate transfer device 17 includes, for example, the endless intermediate transfer belt 110 and a belt cleaning device 90. The intermediate transfer device 17 further includes, for example, the driving roller 15, the secondary transfer backup roller 16, and the four primary transfer bias rollers 62S, 62G, 62R, 62B, and 62K are also provided.

The endless intermediate transfer belt 110 is entrained around a plurality of tension rollers such as the driving rollers 15 disposed inside the loop of the intermediate transfer belt 110. The endless intermediate transfer belt 110 is endlessly moved in a clockwise direction in FIG. 6 by the rotation of the driving rollers 15 driven by a belt driving motor.

The primary transfer bias rollers 62S, 62G, 62R, 62B, and 62K for S, G, R, B, and K are disposed in contact with the back surface (inner circumferential surface) of the intermediate transfer belt 110. A primary transfer bias output from a power source is applied to each of the primary transfer bias rollers 62S, 62G, 62R, 62B, and 62K. The primary transfer bias rollers 62S, 62G, 62R, 62B, and 62K press the intermediate transfer belt 110 toward the photoconductors 1S, 1G, 1R, 1B, and 1K, respectively, from the back surface of the intermediate transfer belt 110. As a result, primary transfer nips for S, G, R, B, and K are formed between the surface (outer circumferential face) of the intermediate transfer belt 110 and the photoconductors 1S, 1G, 1R, 1B, and 1K in contact with the outer circumferential face of the intermediate transfer belt 110. Due to the influence of the primary transfer bias, primary transfer electric fields are formed at the primary transfer nips between the photoconductors 1S, 1G, 1R, 1B, and 1K and the primary transfer bias rollers 62S, 62G, 62R, 62B, and 62K.

The S toner image formed on the photoconductor 1S for S is primarily transferred onto the intermediate transfer belt 110 by the influence of the primary transfer electric field and the nip pressure. A G toner image, an R toner image, a B toner image, and a K toner image respectively formed on the photoconductors 1G, 1R, 1B, and 1K for G, R, B, and K are sequentially superimposed and primarily transferred onto the S toner image. The primary transfer by the superimposition results in the formation of a multicolor toner image on the intermediate transfer belt 110.

The multicolor toner image formed on the intermediate transfer belt 110 is secondarily transferred to a recording sheet at a secondary transfer nip described later. The residual toner remaining on the surface of the intermediate transfer belt 110 that has passed through the secondary transfer nip is removed by the belt cleaning device 90 that sandwiches the intermediate transfer belt 110 with the driving rollers 15.

The secondary transfer device 22 disposed below the intermediate transfer device 17 brings a secondary transfer roller 23 into contact with a portion of the intermediate transfer belt 110 wound around the secondary transfer backup roller 16, to form the secondary transfer nip. A secondary transfer bias having the same polarity as the toner is applied to the secondary transfer backup roller 16, whereas the secondary transfer roller 23 is grounded. As a result, a secondary transfer electric field for electrostatically moving the multicolor toner image on the intermediate transfer belt 110 from the belt side toward the secondary transfer roller 23 side is formed at the secondary transfer nip. The action of the secondary transfer electric field and the nip pressure secondarily transfers the multicolor toner image onto the recording sheet, which is fed into the secondary transfer nip by the registration roller pair 49 in synchronization with the multicolor toner image on the intermediate transfer belt 110.

The feeding device 200 provided in a lower portion of the housing of the printer 100 has a feeding cassette 44 and a paper bank 43 that accommodate inside a plurality of recording sheets in a sheet bundle in a state of being stacked. A feeding roller 42 is pressed against an uppermost recording sheet of the sheet bundle accommodated in each of the paper bank 43 and the feeding cassette 44. The feeding roller 42 is rotated to feed the uppermost recording sheet toward a feeding passage 46.

A plurality of conveyance roller pairs 47 is disposed along the feeding passage 46 that receives the recording sheet fed from the paper bank 43 or the feeding cassette 44. The registration roller pair 49 is disposed around an end of the feeding passage 46. The recording sheet is conveyed through the feeding passage 46 toward the registration roller pair 49. The recording sheet conveyed toward the registration roller pair 49 is sandwiched between the rollers of the registration roller pair 49. On the other hand, in the intermediate transfer device 17, the multicolor toner image formed on the intermediate transfer belt 110 enters the secondary transfer nip along with the endless movement of the intermediate transfer belt 110.

The activation of the registration roller pair 49 is timed to feed the recording sheet sandwiched between the rollers of the registration roller pair 49 to the secondary transfer nip to bring the recording sheet into close contact with the multicolor toner image at the secondary transfer nip. As a result, the multicolor toner image on the intermediate transfer belt 110 is brought into close contact with the recording sheet at the secondary transfer nip. Then, the toner image is secondarily transferred onto the recording sheet to be a full-color image on the white recording sheet. After the recording sheet thus bearing the full-color image exits the secondary transfer nip as the secondary transfer roller 23 is driven to rotate, the recording sheet is sent to the fixing device 25 via a sheet conveyance unit including a conveyance belt.

The fixing device 25 includes a belt unit that endlessly moves a fixing belt 26 entrained around two rollers and a pressure roller 27 that is pressed against one of the rollers of the belt unit. The fixing belt 26 and the pressure roller 27 receive the recording sheet from the sheet conveyance unit and sandwich the recording sheet at a fixing nip formed between the fixing belt 26 and the pressure roller 27 in contact with each other. A fixing roller, which is one of the two rollers of the belt unit and is pressed by the pressure roller 27, includes a heat source (heater) inside to heat the fixing belt 26 by heat generation of the heat source. The heated fixing belt 26 heats the recording sheet sandwiched at the fixing nip. The full-color image is fixed on the recording sheet by the influence of the heating and the nip pressure.

The recording sheet subjected to the fixing processing in the fixing device 25 is stacked on a stack unit protruding from the left side plate of the housing of the copier, or is returned to the secondary transfer nip to form a toner image on the other surface.

When a document is copied, for example, a bundle of document sheets is placed on a document tray 31 of the automatic document feeder 400. In a case where the bundle of sheet documents is a one-side-bound document closed like a book, the document is placed on a contact glass 32. Prior to this setting, the automatic document feeder 400 is opened with respect to the copier body, and the contact glass 32 of the scanner 300 is exposed. After the one-side-bound document is placed on the contact glass 32, the one-side-bound document is pressed by the closed automatic document feeder 400.

When the copy start switch is pressed after the document is set in this manner, the document reading operation by the scanner 300 is started. On the other hand, in a case where the bundle of document sheets is placed on the automatic document feeder 400, the automatic document feeder 400 automatically feeds the document sheets to the contact glass 32 prior to the document reading operation.

In the document reading operation, first, both the first carriage 33 and the second carriage 34 start traveling, and light is emitted from a light source provided in the first carriage 33. Then, reflected light from the document surface is reflected by a mirror provided in the second carriage 34, passes through the imaging forming lens 35, and then enters the reading sensor 36. The reading sensor 36 generates image information according to the incident light.

In parallel with the above-described document reading operation, the components of the developing stations 18S, 18G, 18R, 18B, and 18K, the intermediate transfer device 17, the secondary transfer device 22, and the fixing device 25 start the respective operations. According to the image information generated by the reading sensor 36, the optical writing device 21 is driven and controlled to form the S, G, R, B, and K toner images on the photoconductors 1S, 1G, 1R, 1B, and 1K, respectively. These toner images are superimposed and transferred onto the intermediate transfer belt 110 to form a multicolor toner image.

Further, at substantially the same time as the start of the document reading operation, the feeding operation is started in the feeding device 200. In the feeding operation, the feeding device 200 selectively rotates one of the feeding rollers 42 to feed recording sheets from the paper bank 43 or the feeding cassette 44. The fed recording sheets are separated one by one by the separation roller 45, enter the reverse feeding passage, and then are conveyed toward the secondary transfer nip by the conveyance roller pair.

In the housing of the printer 100, a controller including a Central Processing Unit (CPU) or the like that controls each component is disposed. A control panel 500 including a liquid crystal display (LCD) and various keys is disposed on the upper surface of the housing. An operator sends a command to the controller through an input operation on the control panel 500 to designate a simplex print mode in which an image is formed only on one side of a recording sheet or a duplex print mode in which images are formed on both sides of the recording sheet.

A bottle container 65 is provided in an upper portion in the housing of the printer 100. The bottle container 65 accommodates toner bottles 51S, 51G, 51R, 51B, and 51K that accommodate S toner, G toner, R toner, B toner, and K toner, respectively, for replenishment. Bottle drivers 52S, 52G, 52R, 52B, and 52K of toner supply devices for S, G, R, B, and K, respectively, are fixed to the bottle container 65. A description of the toner supply devices is deferred. The bottle drivers 52S, 52G, 52R, 52B, and 52K for S, G, R, B, and K detachably hold the toner bottles 51S, 51G, 51R, 51B, and 51K, respectively.

In FIG. 6, the developing stations 18S, 18G, 18R, 18B, and 18K of the respective colors are arranged so as to primarily transfer the toner images superimposed on the intermediate transfer belt 110 in the order of S, G, R, B, and K. However, depending on the type of the special color S, the color order of superimposition may be changed.

For example, in a case where the special color S is transparent, a transparent toner layer is typically formed to impart gloss to the image. In this case, the order of colors to be superimposed may be S, G, R, B, and K, which may be referred to as a default color order in the following description, as illustrated in FIG. 6. Specifically, when the multicolor toner image formed on the intermediate transfer belt 110 by the superimposition in the default color order is secondarily transferred to the recording sheet, as illustrated in FIG. 7A, the S toner among the respective color toners is positioned on the uppermost side (surface layer side). When such a multicolor toner image is passed through the fixing device 25 together with the recording sheet SH, as illustrated in FIG. 7B, a multicolor toner image in which a K toner layer, a B toner layer, an R toner layer, a G toner layer, and a transparent toner layer are sequentially laminated is formed on the surface of the recording sheet SH. The uppermost transparent toner layer serves to impart glossiness to the color image.

### Hardware Configuration of Computer

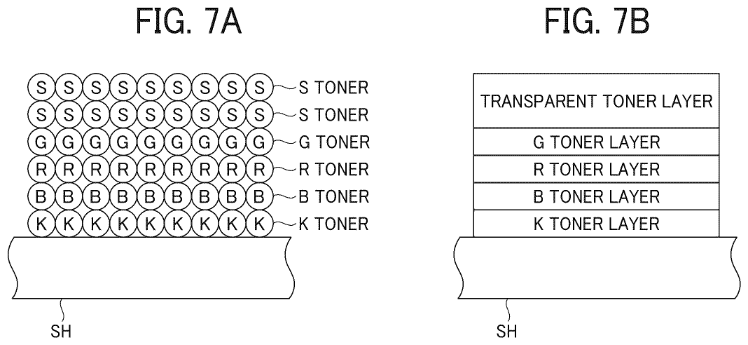

The customer terminal 10, the user terminal 20, and the provision server 30 in the present embodiment are realized by a computer. FIG. 8 is a diagram illustrating an example of a hardware configuration in a case where the customer terminal 10, the user terminal 20, and the provision server 30 are realized by a computer.

As illustrated in FIG. 8, the computer according to the present embodiment includes a CPU 501, a read only memory (ROM) 502, a random access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, a digital versatile disk rewritable (DVD-RW) drive 514, and a media I/F 516.

Among these, the CPU 501 controls the operation of the entire computer. The ROM 502 stores a program used for driving the CPU 501 such as initial program loader (IPL). The RAM 503 is used as a work area for the CPU 501. The HD 504 stores various data such as programs. The HDD controller 505 controls the reading and writing of various kinds of data from and to the HD 504 under control of the CPU 501.

The display 506 displays various types of information such as a cursor, a menu, a window, a character, or an image. The external device connection I/F 508 is an interface that connects the computer to various external devices. The external device in this case is, for example, a universal serial bus (USB) memory, a printer, or the like. The network I/F 509 is an interface that enables data communication through the communication network N1. The bus line 510 is an address bus, a data bus, or the like for electrically connecting each component such as the CPU 501.

According to the present embodiment, the keyboard 511 serves as an input device provided with a plurality of keys for allowing a user to enter, for example, characters, numerical values, or various instructions. The pointing device 512 serves as an input device used to select or execute various instructions, select a target for processing, or move a cursor. The DVD-RW drive 514 controls reading and writing of various kinds of data from and to a DVD-RW 513, which serves as a removable recording medium according to the present embodiment. In addition, not only the DVD-RW but also a digital versatile disk recordable (DVD-R) or the like may be used. The media I/F 516 controls reading or writing (storing) of data from or to a recording medium 515 such as a flash memory.

### Functional Configuration of Printing System

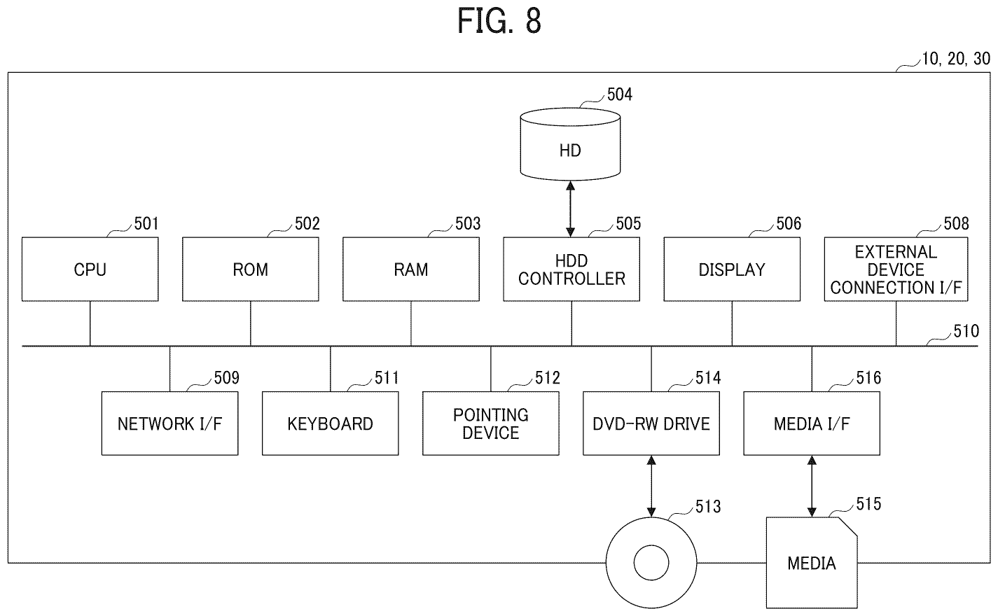

Referring to FIG. 9, a description is given below of a functional configuration of the printing system according to the present embodiment. FIG. 9 is a block diagram illustrating a functional configuration of the printing system according to the present embodiment.

### Functional Configuration of Customer Terminal

As illustrated in FIG. 9, the customer terminal 10 according to the present embodiment includes a request input unit 101 and a print request unit 102.

The request input unit 101 and the print request unit 102 are realized, for example, by a process in which a program developed on the RAM 503 from the ROM 502 illustrated in FIG. 8 is executed by the CPU 501 and the network I/F 509.

The request input unit 101 receives an input of request information for requesting manufacture of the printed material according to the operation of the customer. The request information includes image data indicating an invisible image to be formed on the printed material, environment information indicating an environment in which the invisible image formed on the printed material is observed, and condition information indicating a condition for forming the invisible image on the printed material. The environment information is, for example, information regarding an environment when a visitor carrying a printed material or a user of the printed material views or uses an invisible image formed on the printed material, and includes information regarding invisible light and illuminance to be described below.

The environment information in the present embodiment includes wavelength information indicating a wavelength of invisible light. The wavelength information may be a numerical value indicating the wavelength of invisible light (for example, in nanometres). The wavelength information may be information indicating a type of a light source that irradiates an invisible image with invisible light (for example, a product number of a black light, and the like).

The environment information in the present embodiment may include illuminance information indicating illuminance of an environment in which an invisible image is observed. The illuminance information may be, for example, a numerical value indicating brightness (for example, in lux). The illuminance information may be, for example, information indicating outdoor or indoor. The illuminance information may be information subdivided by brightness (classification such as bright, dark, and the like), weather (sunshine, cloudiness, rain, and the like), or a time zone (morning, daytime, evening, night, and the like) for outdoor or indoor, respectively.

The condition information according to the present embodiment includes medium information indicating an image forming medium that forms an invisible image. The medium information is, for example, information indicating the type of sheets such as plain paper, thick paper, and transparent film. The medium information may be information subdivided by a thickness (it may be classified as thin, thick, or the like, or may be a numerical value (for example, in millimeters) indicating the thickness), a base color (transparent, white, black, and the like), or a material (coated paper, matte-coated paper, high-quality paper, and the like) for each sheet type.

The print request unit 102 transmits a print request including the request information input to the request input unit 101. The print request transmitted from the print request unit 102 is sent to the user terminal 20. In the present embodiment, the print request unit 102 transmits the print request to an intermediary service that mediates the print request via the Internet. The print request unit 102 may directly transmit the print request to the user terminal 20. The print request unit 102 may transmit the print request to a receiving server for receiving the print request installed in the printer B.

### Functional Configuration of User Terminal

As illustrated in FIG. 9, the user terminal 20 according to the present embodiment includes a request reception unit 201, a setting request unit 202, a setting acquisition unit 203, and a job transmission unit 204.

The request reception unit 201, the setting request unit 202, the setting acquisition unit 203, and the job transmission unit 204 are realized, for example, by a process in which a program developed on the RAM 503 from the ROM 502 illustrated in FIG. 8 is executed by the CPU 501 and the network I/F 509.

The request reception unit 201 accepts a print request transmitted from the customer terminal 10. In the present embodiment, the request reception unit 201 receives a print request from an intermediary service via the Internet. The request reception unit 201 may receive a print request from the customer terminal 10. The request reception unit 201 may acquire the print request from a receiving server installed in the printer B.

The setting request unit 202 transmits an acquisition request for an image forming profile to the provision server 30 according to the operation of the user. The acquisition request includes environment information and condition information based on the print request received by the request reception unit 201. The setting request unit 202 transmits the acquisition request for an image forming profile according to the operation of the user on a request screen displayed on the display 506 of the user terminal 20.

The setting request unit 202 may transmit the acquisition request after changing or adding the environment information and the condition information included in the print request according to the operation of the user on the request screen. For example, the setting request unit 202 may add, to the condition information, model information of the image forming apparatus IF and information indicating a printing consumable such as toner or ink used in the image forming apparatus IF.

The setting acquisition unit 203 acquires the image forming profile by receiving the image forming profile from the provision server 30.

The job transmission unit 204 transmits the print job to the image forming apparatus IF based on the print request received by the request reception unit 201. The print job includes the image data included in the print request and the image forming profile acquired by the setting acquisition unit 203.

### Functional Configuration of Providing Server

As illustrated in FIG. 9, the provision server 30 according to the present embodiment includes a setting information storage unit 301, a request reception unit 302, a setting selection unit 303, a charging unit 304, and a setting output unit 305.

The setting information storage unit 301 is realized by using, for example, an HD 504 illustrated in FIG. 8. Data stored in the HD 504 is read or written via the HDD controller 505, for example.

The request reception unit 302, the setting selection unit 303, the charging unit 304, and the setting output unit 305 are realized, for example, by a process in which a program developed on the RAM 503 from the ROM 502 illustrated in FIG. 8 is executed by the CPU 501 and the network I/F 509.

The setting information storage unit 301 stores a predetermined image forming profile and a setting information table for selecting an image forming profile. The setting information table is a table in which information indicating an image forming profile is set for each combination of environment information and condition information.

The setting information storage unit 301 may store a conversion table for converting the environment information or the condition information to refer to the setting information table. For example, in a case where the setting information table uses the wavelength of the invisible light as a key and the condition information input by the customer is the product number of the black light, the setting information storage unit 301 may store a wavelength conversion table that associates the product number of the black light with the wavelength of the invisible light.

The image forming profile includes color conversion information and image forming parameters. The color conversion information is information for converting color information of an invisible image into color information when the invisible image is formed on an image forming medium. The color conversion information may be, for example, an adhesion amount notch setting (for example, R=−1, G=0, B=−1, etc.) or a color conversion table.

The image forming parameter is control information for controlling the operation of the image forming apparatus IF. The image forming parameters may vary depending on the type or model of the image forming apparatus IF. The image forming parameters may include, for example, control parameters of an image forming process in electrophotography, such as linear velocity (high speed, low speed, etc.), fixing temperature, primary transfer, secondary transfer, and the like. The image forming parameters may include an ink ejection amount, a drying time, and the like in the inkjet printing machine.

The request reception unit 302 receives the acquisition request for the image forming profile by receiving the acquisition request for the image forming profile from the user terminal 20. The request reception unit 302 also receives input of environment information and condition information.

The setting selection unit 303 selects an image forming profile for forming an invisible image from the image forming profile stored in the setting information storage unit 301 based on the acquisition request for the image forming profile received by the request reception unit 302. Specifically, the setting selection unit 303 refers to the setting information table stored in the setting information storage unit 301 to specify the image forming profile based on the environment information and the condition information included in the acquisition request received by the request reception unit 302, and reads the specified image forming profile from the setting information storage unit 301.

The charging unit 304 generates charging information regarding a consideration for the image forming profile. The charging unit 304 may generate the charging information based on the number of printed materials that can be printed using the image forming profile, or may generate the charging information based on the expiration date of the image forming profile. The charging unit 304 may generate the charging information only in a case where the image forming profile is provided for a fee.

The setting output unit 305 transmits the image forming profile selected by the setting selection unit 303 and the charging information generated by the charging unit 304 to the user terminal 20. In a case where the image forming profile is provided free of charge, the setting output unit 305 may transmit only the image forming profile.

### Functional Configuration of Image Forming Apparatus

As illustrated in FIG. 9, the image forming apparatus IF according to the present embodiment includes a job reception unit 401 and a print controller 402.

The job reception unit 401 receives a print job for forming an invisible image on an image forming medium. The job reception unit 401 may receive a print job by receiving the print job from the user terminal 20, or may receive a print job according to an operation on an operation panel of the image forming apparatus IF.

The print controller 402 forms an invisible image on the image forming medium based on the print job received by the job reception unit 401. Specifically, the print controller 402 performs color conversion on the invisible image in accordance with the color conversion information included in the image forming profile. Then, the print controller 402 controls the operation of each unit of the image forming apparatus IF according to the image forming parameter included in the image forming profile, thereby forming the invisible image after the color conversion on the image forming medium.

### Processing Procedure of Image Forming Method

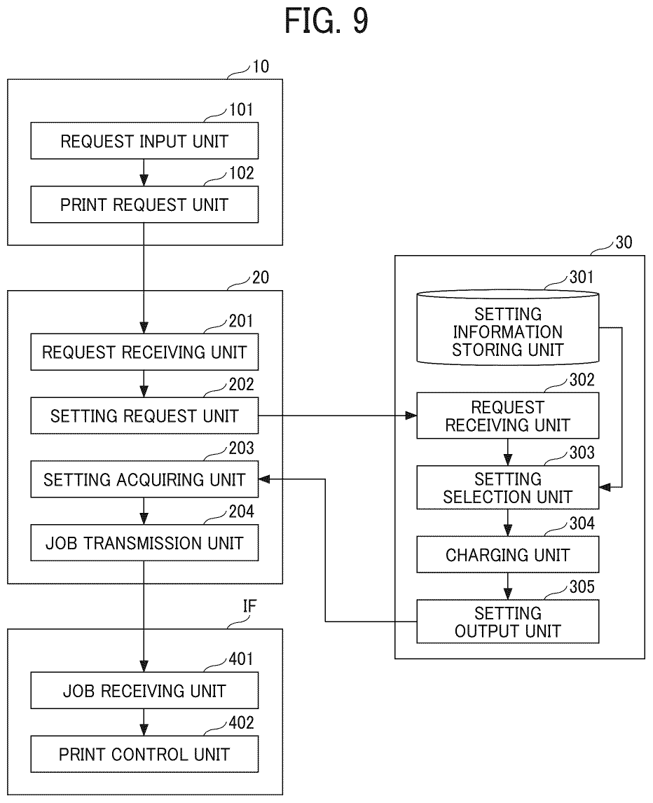

A processing procedure of the image forming method executed by the printing system 1000 according to the present embodiment will be described with reference to FIGS. 10 to 13. FIG. 10 is a flowchart illustrating an example of a processing procedure of the image forming method according to the present embodiment.

In step S11, the request input unit 101 of the customer terminal 10 receives an input of request information for requesting manufacturing of the printed material according to the operation of the customer. The request input unit 101 sends the input request information to the print request unit 102.

In step S12, the print request unit 102 of the customer terminal 10 receives request information from the request input unit 101. Next, the print request unit 102 transmits a print request including the request information to the intermediary service. The intermediary service receives request information from the customer terminal 10. The intermediary service transmits the request information to the user terminal 20.

In step S13, the request reception unit 201 of the user terminal 20 receives the request information from the intermediary service. Next, the request reception unit 201 receives the received request information. Then, the request reception unit 201 sends the request information to the setting request unit 202.

In step S14, the setting request unit 202 of the user terminal 20 receives the request information from the request reception unit 201. Next, the setting request unit 202 displays a request screen on the display 506. Information included in the request information is displayed on the request screen.

### Request Screen

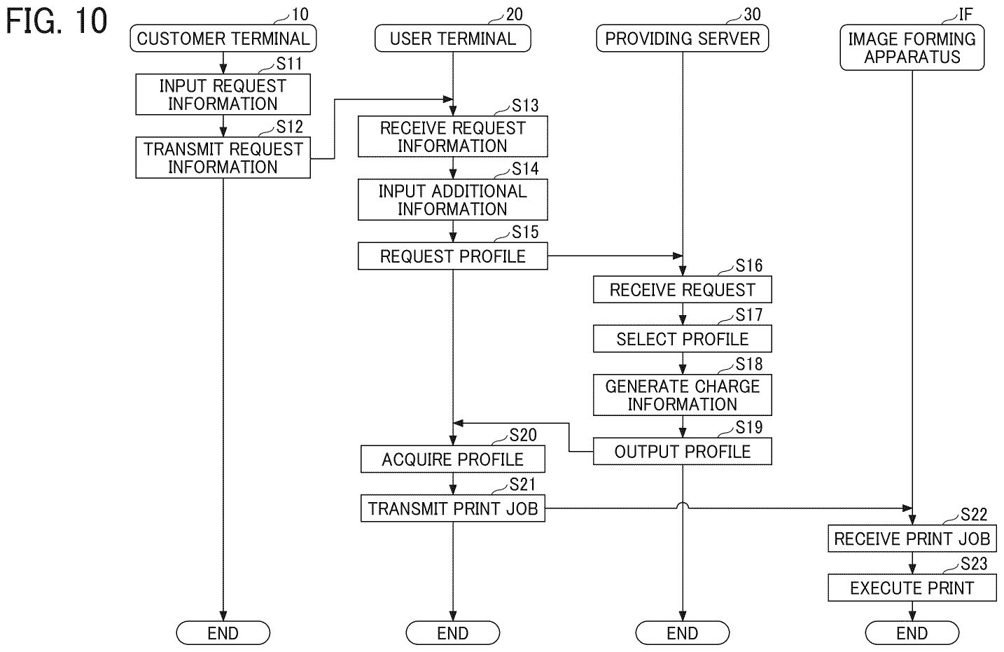

A request screen according to the present embodiment will be described with reference to FIG. 11. FIG. 11 is a diagram illustrating an example of a request screen according to the present embodiment.

As illustrated in FIG. 11, the request screen 600 according to the present embodiment includes an image display field 610, an environment input area 620, a condition input area 630, a send button 640, and a cancel button 650. The environment input area 620 includes a scene selection field 621 and a light source selection field 622. The condition input area 630 includes a sheet selection field 631, a model selection field 632, and a consumables selection field 633.

An invisible image to be formed on the printed material is displayed in the image display field 610 (an invisible image to be printed invisibly on a printed material is displayed in a visible state). The invisible image is an invisible image input through the customer terminal 10. In the image display field 610, the invisible image may be edited according to the operation of the user. The editing of the invisible image may include, for example, rotation, scaling, position correction, trimming, noise elimination, and the like.

The scene selection field 621 is a selection field for selecting an environment in which an invisible image is observed. The light source selection field 622 is a selection field for selecting a light source of invisible light. The scene selection field 621 and the light source selection field 622 initially display items corresponding to the environment information input through the customer terminal 10. The scene selection field 621 and the light source selection field 622 can be changed according to the operation of the user.

The sheet selection field 631 is a selection field for selecting an image forming medium. The sheet selection field 631 initially displays an item corresponding to the condition information input through the customer terminal 10. The sheet selection field 631 can be changed according to the operation of the user.

The model selection field 632 is a selection field for selecting a model of the image forming apparatus IF. The consumables selection field 633 is a selection field for selecting a consumable used by the image forming apparatus IF. The model selection field 632 and the consumables selection field 633 may be selected by the user according to the environment information and the condition information selected by the customer from the image forming apparatus IF or the consumable available in the printer B.

In a case where the profile selection service is provided to the printer B using a specific model or a specific consumable, the request screen 600 may not include the model selection field 632 or the consumables selection field 633. For example, in a case where a manufacturer, a seller, or the like that provides the image forming apparatus IF to the printer B provides a profile providing service, a service can be provided based on a model or a consumable used by the printer B.

When the user presses the send button 640, the setting request unit 202 receives an operation of transmitting an acquisition request for an image forming profile. When the user presses the cancel button 650, the information input on the request screen 600 is discarded, and the request screen 600 is closed.

Referring back to FIG. 10, a description is given. In step S15, when the setting request unit 202 of the user terminal 20 receives the operation of transmitting the acquisition request for an image forming profile, the setting request unit 202 of the user terminal 20 generates the acquisition request for an image forming profile based on the information input on the request screen 600. Then, the setting request unit 202 transmits the acquisition request for an image forming profile to the provision server 30.

In step S16, the request reception unit 302 of the provision server 30 receives the acquisition request for an image forming profile from the user terminal 20. Next, the request reception unit 302 receives the received acquisition request for an image forming profile. Then, the request reception unit 302 sends the acquisition request for an image forming profile to the setting selection unit 303.

In step S17, the setting selection unit 303 of the provision server 30 receives the acquisition request for an image forming profile from the request reception unit 302. Next, the setting selection unit 303 reads the wavelength conversion table and the setting information table stored in the setting information storage unit 301.

### Wavelength Conversion Table

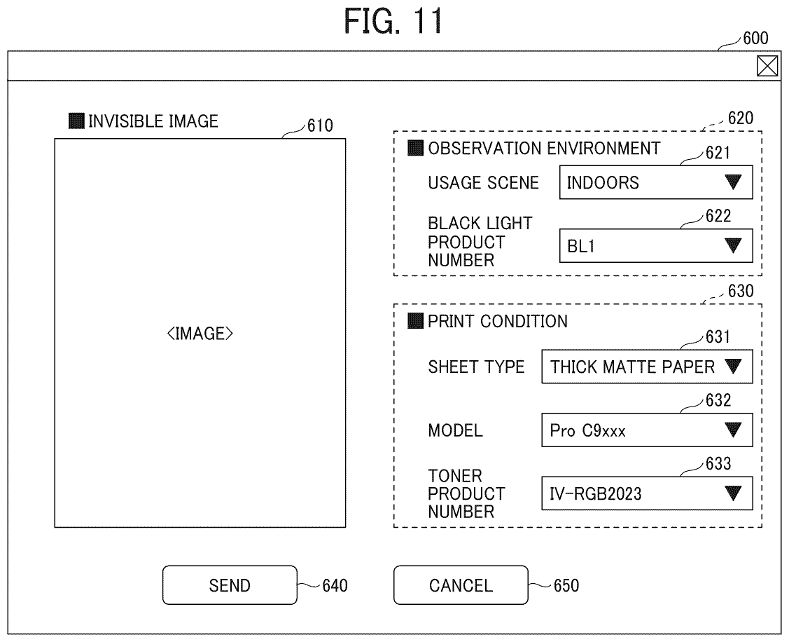

A wavelength conversion table according to the present embodiment will be described with reference to FIG. 12. FIG. 12 is a diagram illustrating an example of a wavelength conversion table according to the present embodiment.

As illustrated in FIG. 12, the wavelength conversion table 700 according to the present embodiment has a product number and a wavelength as data items. The product number is a product number of a black light serving as a light source of invisible light. The wavelength is a wavelength of invisible light irradiated by the black light.

### Setting Information Table

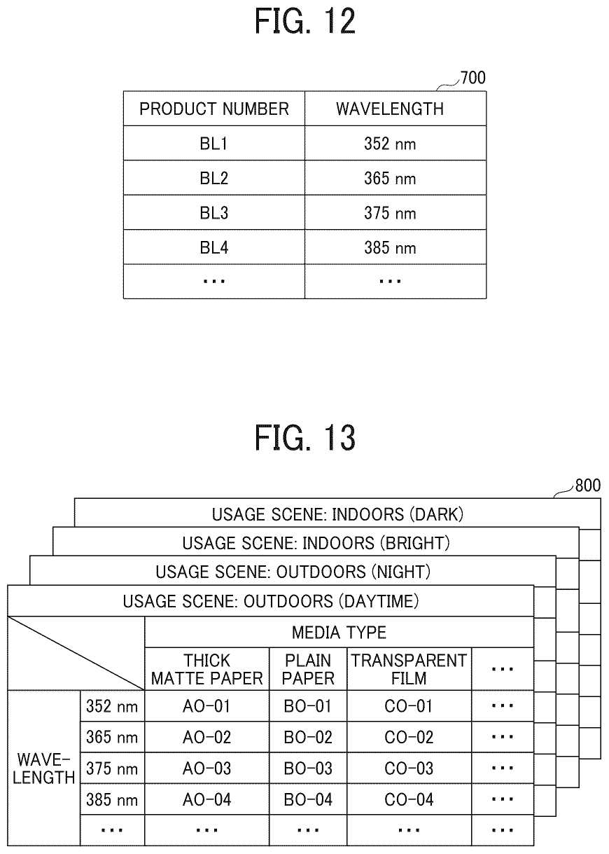

A setting information table according to the present embodiment will be described with reference to FIG. 13. FIG. 13 is a diagram illustrating an example of a setting information table according to the present embodiment.

As illustrated in FIG. 13, the setting information table 800 according to the present embodiment includes a column indicating a medium type and a row indicating a wavelength, and identification information for identifying an image forming profile is set for a combination of the medium type and the wavelength. The medium type is information indicating the type of an image forming medium. The wavelength is information indicating a wavelength of invisible light.

In the setting information table, an appropriate image forming profile is set in advance for a combination of the medium type and the wavelength. Although the image forming profile corresponding to each combination can be arbitrarily set, in the present embodiment, the image forming profile is set according to the rules exemplified below. Hereinafter, three rules will be exemplified, and the setting rule of the image forming profile is not limited thereto, and the image forming profile can be set according to various rules.

The first rule is a setting rule of the image forming profile according to the wavelength of the invisible light. Since the invisible light becomes closer to the blue wavelength of visible light as the wavelength is longer, the entire invisible image looks closer to blue. The longer the wavelength of the invisible light, the weaker the invisible red response tends to be. In view of these properties, in the first rule, an image forming profile is set for forming an invisible image in which the invisible red is darker as the wavelength of the invisible light is longer.

The second rule is a setting rule of the image forming profile according to the type of the image forming medium. For example, in a case where the image forming medium is a transparent sheet, light emission of an invisible image is weakened due to high translucency. In a case where the base color of the image forming medium is black, the light emission of the invisible image is similarly weakened. In view of these properties, in the second rule, an image forming profile is set for forming an invisible image in which all invisible colors are darker as the base color of the image forming medium is closer to transparent or black.

The third rule is a setting rule of the image forming profile according to the illuminance of the observation environment. Even when the light source of the invisible light is the same, the appearance of the invisible image changes depending on the brightness of the surrounding fluorescent lamp or the like. In view of this property, in the third rule, an image forming profile is set for forming an invisible image in which all invisible colors are darker as the illuminance of the environment is higher in which the invisible image is observed.

Referring back to FIG. 10, a description is given. The setting selection unit 303 first selects a setting information table corresponding to the usage scene included in the environment information. Next, using the wavelength conversion table, the setting selection unit 303 acquires the wavelength of the invisible light from the product number of the black light included in the environment information. Subsequently, the setting selection unit 303 specifies the identification information of the image forming profile from a combination of the wavelength of the invisible light and the medium type included in the condition information using the setting information table corresponding to the usage scene. Next, the setting selection unit 303 reads the image forming profile identified by the specified identification information from the setting information storage unit 301. Then, the setting selection unit 303 sends the image forming profile to the charging unit 304 and the setting output unit 305.

In step S18, the charging unit 304 of the provision server 30 receives the image forming profile from the setting selection unit 303. Next, the charging unit 304 generates the charging information based on the image forming profile. The charging unit 304 may generate the charging information based on the number of printed materials that can be printed with the image forming profile, the expiration date of the image forming profile, or the like. Then, the charging unit 304 sends the charging information to the setting output unit 305. In a case where the profile providing service provides the image forming profile for free, step S8 may be skipped.

In step S19, the setting output unit 305 of the provision server 30 receives the image forming profile from the setting selection unit 303. In addition, the setting output unit 305 receives the charging information from the charging unit 304. Next, the setting output unit 305 transmits the image forming profile to the user terminal 20 together with the charging information.

In step S20, the setting acquisition unit 203 of the user terminal 20 receives the image forming profile and the charging information from the provision server 30. Next, the setting acquisition unit 203 displays the received image forming profile and charging information on the display 506.

In step S21, the job transmission unit 204 of the user terminal 20 receives the input of the print job according to the operation by the user. The print job is input based on the request information received in step S13 and the image forming profile received in step S20. Specifically, the print job includes an invisible image, condition information included in the request information, and an image forming profile. Then, the job transmission unit 204 transmits the received print job to the image forming apparatus IF.

In step S22, the job reception unit 401 of the image forming apparatus IF receives the print job from the user terminal 20. Next, the job reception unit 401 sends the print job to the print controller 402.

In step S23, the print controller 402 of the image forming apparatus IF receives the print job from the job reception unit 401. Next, the print controller 402 performs color conversion on the invisible image in accordance with the color conversion information included in the image forming profile. Then, the print controller 402 controls the operation of each unit of the image forming apparatus IF according to the image forming parameter included in the image forming profile, thereby forming the invisible image after the color conversion on the image forming medium.

### Advantageous Effects of Embodiment

When an invisible image can be expressed only in one color, it is difficult to express a decorative image or the like suitable for an environment such as a facility or a venue. In addition, in an invisible image, appearance differs depending on various factors such as a wavelength of invisible light, peripheral illuminance, and characteristics of an image forming medium, and thus, only color conversion according to a difference in light sources is not sufficient to form an appropriate image.

The provision server 30 according to the present embodiment outputs an image forming profile according to a combination of environment information indicating an environment in which an image is observed and condition information indicating a condition for forming an image. Therefore, according to the present embodiment, an appropriate image forming profile can be output according to the environment in which an image is observed and the condition for forming the image. In one aspect, according to the present embodiment, an image observed as intended by the user in a given environment can be formed and visibility of the image in the given environment can be improved.

The image according to the present embodiment may be an invisible image in which the light emission intensity of invisible light is higher than the light emission intensity of visible light. The invisible image may be formed in a plurality of colors in which the light emission intensity of invisible light is higher than the light emission intensity of the visible light. Therefore, according to the present embodiment, an image forming profile can be output that appropriately forms an invisible image including a plurality of invisible colors.

The image forming profile according to the present embodiment may include color conversion information and image forming parameters of the image forming apparatus IF. Therefore, according to the present embodiment, the image forming apparatus IF can be controlled to appropriately convert the color of the image and appropriately form an image after the color conversion.

The environment information according to the present embodiment may include wavelength information indicating a wavelength of invisible light. The provision server 30 may output an image forming profile for forming an invisible image in which the invisible red is darker as the wavelength is longer. Therefore, according to the present embodiment, an image forming profile can be output that appropriately forms an invisible image according to the wavelength of invisible light.

The condition information according to the present embodiment may include medium information indicating a medium on which an image is formed. The provision server 30 may output an image forming profile for forming an invisible image in which all invisible colors are darker as the base color of the medium is closer to transparent or black. Therefore, according to the present embodiment, an image forming profile can be output that appropriately forms an invisible image according to a medium on which an image is formed.

The environment information according to the present embodiment may include illuminance information indicating illuminance of an environment in which an image is observed. The provision server 30 may output an image forming profile for forming an invisible image in which all invisible colors are darker as the illuminance is higher.

Therefore, according to the present embodiment, an image forming profile can be output that appropriately forms an invisible image according to the illuminance of the environment in which an image is observed.

A description is given below of some other embodiments of the present disclosure.

In the above embodiment, the configuration example in which the provision server 30 that provides the profile providing service is installed in the service provider C has been described. The provision server 30 may be installed on-premises in the printer B and operated only for the image forming apparatus IF installed in the printer B. In addition, software that performs processing similar to that of the profile providing service may be installed in the user terminal 20, and the image forming profile may be provided by the user terminal 20 alone.

In the above embodiment, the printer B manufactured the printed material in response to the request of the facility operator A. The image forming apparatus IF may be installed in the facility operator A, and the customer terminal 10 may acquire the image forming profile through the profile providing service. In this case, the provision server 30 may be installed in the facility operator A, or software that performs processing similar to the profile providing service may be installed in the customer terminal 10.

### Supplement

In the above embodiment, the provision server 30 is an example of an information processing apparatus. The printing system 1000 is an example of an information processing system. The user terminal 20 is an example of a terminal device. The image forming profile is an example of setting information. The image forming parameter is an example of control information.

Each of the functions of the embodiments described above may be implemented by one or more processing circuits or circuitry. Here, the term “processing circuit” in the present description includes a processor programmed to execute each function by software, such as a processor implemented by an electronic circuit, and devices, such as an application specific integrated circuit (ASIC), a digital signal processor (DSP), a field programmable gate array (FPGA), and a conventional circuit module arranged to execute each function described above.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

A description is now given below of several aspects of the present disclosure.

### First Aspect

An information processing apparatus includes: a request reception unit that receives an input of environment information indicating an environment in which an image is observed and condition information indicating a condition for forming the image; and a setting output unit that outputs setting information of an image forming apparatus that forms the image according to a combination of the environment information and the condition information.

### Second Aspect

In the information processing apparatus according to the first aspect, the image is an invisible image in which a light emission intensity of invisible light is higher than a light emission intensity of visible light.

### Third Aspect

In the information processing apparatus according to the second aspect, the invisible image is formed in a plurality of colors in which a light emission intensity of the invisible light is higher than a light emission intensity of the visible light.

### Fourth Aspect

In the information processing apparatus according to the second or third aspect, the environment information includes wavelength information indicating a wavelength of the invisible light.

### Fifth Aspect

In the information processing apparatus according to the fourth aspect, the setting output unit outputs the setting information for forming the image in which an invisible red is darker as the wavelength is longer.

### Sixth Aspect

In the information processing apparatus of any one of the first to fifth aspects, the environment information includes illuminance information indicating illuminance of the environment.

### Seventh Aspect

In the information processing apparatus according to the sixth aspect, the setting output unit outputs the setting information for forming the image in which all invisible colors are darker as the illuminance is higher.

### Eighth Aspect

In the information processing apparatus of any one of the first to seventh aspects, the condition information includes medium information indicating a medium on which the image is formed.

### Aspect 9

In the information processing apparatus according to the eighth aspect, the setting output unit outputs the setting information for forming the image in which all invisible colors are darker as a base color of the medium is closer to transparent or black.

### Tenth Aspect

In the information processing apparatus of any one of the first to ninth aspects, the setting information includes color conversion information for converting a color of the image and control information for controlling an operation of the image forming apparatus.

### Eleventh Aspect

In the information processing apparatus of any one of the first to tenth aspects, the setting output unit outputs charging information regarding a consideration for the setting information.

### Twelfth Aspect

An information processing system is provided in which a terminal device and an information processing apparatus are communicated via a network. The terminal device includes: a setting request unit that transmits environment information indicating an environment in which an image is observed and condition information indicating a condition for forming the image to the information processing apparatus; and a setting acquisition unit that receives setting information of an image forming apparatus for forming the image from the information processing apparatus. The information processing apparatus includes: a request reception unit that receives the environment information and the condition information from the terminal device; and a setting output unit that transmits the setting information to the terminal device according to a combination of the environment information and the condition information.

### Aspect 13

A method for processing information causes a computer to execute: a procedure of receiving an input of environment information indicating an environment wherein an image is observed and condition information indicating a condition for forming the image; and a procedure of outputting setting information of an image forming apparatus that forms the image according to a combination of the environment information and the condition information.

### Aspect 14

A program causes computer to execute: a procedure of receiving an input of environment information indicating an environment in which an image is observed and condition information indicating a condition for forming the image; and a procedure of outputting setting information of an image forming apparatus that forms the image according to a combination of the environment information and the condition information.

1. An information processing apparatus, comprising processing circuitry configured to:
receive an input of environment information indicating an environment in which an image is observed and condition information indicating a condition for forming the image; and
output setting information of an image forming apparatus that forms the image according to a combination of the environment information and the condition information.

2. The information processing apparatus according to claim 1,
wherein the image is an invisible image in which a light emission intensity of invisible light is higher than a light emission intensity of visible light.

3. The information processing apparatus according to claim 2,
wherein the invisible image is formed in a plurality of colors in which a light emission intensity of the invisible light is higher than a light emission intensity of the visible light.

4. The information processing apparatus according to claim 2,
wherein the environment information includes wavelength information indicating a wavelength of the invisible light.

5. The information processing apparatus according to claim 4,
wherein the processing circuitry is configured to output the setting information for forming the image in which an invisible red is darker as the wavelength is longer.

6. The information processing apparatus according to claim 1,
wherein the environment information includes illuminance information indicating illuminance of the environment.

7. The information processing apparatus according to claim 6,
wherein the processing circuitry is configured to output the setting information for forming the image in which all invisible colors are darker as the illuminance is higher.

8. The information processing apparatus according to claim 1,
wherein the condition information includes medium information indicating a medium on which the image is formed.

9. The information processing apparatus according to claim 8,
wherein the processing circuitry is configured to output the setting information for forming the image in which all invisible colors are darker as a base color of the medium is closer to transparent or black.

10. The information processing apparatus according to claim 1,
wherein the setting information includes color conversion information for converting a color of the image and control information for controlling an operation of the image forming apparatus.

11. The information processing apparatus according to claim 1,
wherein the processing circuitry is configured to output charging information regarding a consideration for the setting information.

12. An information processing system, comprising:
a terminal device; and
an information processing apparatus to communicate with the terminal device via a network,
the terminal device including processing circuitry configured to:
transmit environment information indicating an environment in which an image is observed and condition information indicating a condition for forming the image to the information processing apparatus; and
receive setting information of an image forming apparatus for forming the image from the information processing apparatus,
the information processing apparatus including processing circuitry configured to:
receive the environment information and the condition information from the terminal device; and
transmit the setting information to the terminal device according to a combination of the environment information and the condition information.

13. A method for processing information that causes a computer to execute:
receiving an input of environment information indicating an environment in which an image is observed and condition information indicating a condition for forming the image; and
outputting setting information of an image forming apparatus that forms the image according to a combination of the environment information and the condition information.
